(19) United States
(12) Patent Application Publication
(10) Pub. No.: US 2019/0143858 A1
(43) Pub. Date: May 16, 2019

(54) Seat Heater

(71) Applicant: The Endeavour Group, Inc., West Jordan, UT (US)

(72) Inventors: Andrew Conner, West Jordan, UT (US); John R. Conner, Holladay, UT (US)

(21) Appl. No.: 15/812,876

(22) Filed: Nov. 14, 2017

(51) Int. Cl. B60N 2/56; H05B 3/14; H05B 1/02

(52) U.S. Cl. CPC B60N 2/5685; H05B 3/145; H05B 2203/029; H05B 1/0238; H05B 2203/017; H05B 3/146

(57) ABSTRACT

Seat heaters, methods for manufacturing seat heaters, and methods for using seat heaters are provided. A seat heater for use in a vehicle seat includes a graphene-containing electrothermal layer, a first polymer layer contacting and extending along a first side of the graphene-containing electrothermal layer, and a second polymer layer contacting and extending along a second side of the graphene-containing electrothermal layer. The seat heater also includes lead wires connected between the graphene-containing electrothermal layer and a heater control system operatively connected to a power supply. The control system may be controlled using an application programming interface running on a mobile electronic device. The graphene-containing electrothermal layer, the first polymer layer, and the second polymer layer form a flexible sheet that is disposed under a cover of a vehicle seat.

### BACKGROUND OF THE INVENTION

### 1. Field of the Invention

The present invention relates to electronic heating devices, and more particularly to an electronic seat heater for vehicles.

### 2. Background and Related Art

Seat heaters are commonly provided in vehicles to increase the comfort of vehicle passengers. Seat heaters often include a warming element or wire that is disposed between a seat cover and an underlying seat pad. The seat pad generally is adapted to deform when sat upon so as to provide comfort to the user of the seat, and may include, for example, a foam later over a spring layer. While the flexibility of the seat increases user comfort, the flexibility provides a significant challenge for designers of seat heaters. The flexibility of vehicle seats presents a problem for seat heater design, as deformation of the seat involves deformation of the underlying heater element or wire, which, when repeated over time can cause thinning or breaks in the heater element or wire. Thinning or breaking of the heating element or wire can reduce the heater efficiency or cause the heater to cease functioning altogether.

To avoid or reduce the possibility of heater failure, the designer may attempt to place the heater element or wire deeper in the seat, where overall deformations of the seat are reduced. While such a design may increase the life of the seat heater, deeper placement of the heater element or wire does not completely eliminate the problems of repeated deformation of the heater element or wire, and the deeper placement of the heater element or wire increases the amount of time it takes for heat to reach the seat occupant. Accordingly, deeper placement of the heater element or wire is not an ideal seat heater design.

Another method that has been used to avoid or reduce the possibility of heater failure is attempting to select placement of the heater element or wire within the seat so as to minimize deformation of the heater element or wire along its length. In other words, wire placement is avoided at locations of the seat that are known or expected to experience more deformation, such as locations expected to wrinkle or crease. While such placement may reduce failure rates of the seat heater, it is difficult to completely predict where wrinkles or creases of the seat will occur for every seat user given differences in anatomy and weight. Accordingly, seat heater failures still occur at an unacceptably high rate.

An additional disadvantage of traditional seat heaters is that heating is typically concentrated at the location of the heating element or wire. Because of this, heating is often uneven, with excessive, even uncomfortable, amounts of heat being generated at the location of the heating element or wire, while locations away from the heating element or wire do not have desired levels of heat. Still another disadvantage of traditional seat heaters is a lack of fine control over the amount of heat generated or over the temperature of the heating element or wire. Most vehicle seat heating systems have only one or two settings, even if one setting is too hot or too cold and no available setting provides a perfect amount of heat. Accordingly, users of seat heaters may have to turn the heater on and off repeatedly, or repeatedly adjust between low and high settings to achieve a desired amount of heat from the seat heater without having the seat heater grow uncomfortably hot.

### BRIEF SUMMARY OF THE INVENTION

Implementation of the invention provides novel seat heaters, methods for manufacturing seat heaters, and methods for using seat heaters. According to an exemplary implementation of the invention, a seat heater for use in a vehicle seat includes a graphene-containing electrothermal layer, a first polymer layer contacting and extending along a first side of the graphene-containing electrothermal layer, and a second polymer layer contacting and extending along a second side of the graphene-containing electrothermal layer. The seat heater also includes lead wires connected between the graphene-containing electrothermal layer and a heater control system operatively connected to a power supply. The graphene-containing electrothermal layer, the first polymer layer, and the second polymer layer form a flexible sheet that is disposed under a cover of a vehicle seat.

The flexible sheet may be shaped to conform to a shape of a portion of the vehicle seat. The graphene-containing electrothermal layer may have a thickness of approximately 0.01 mil. The first polymer layer and the second polymer layer may have a thickness of between approximately 5 mil and approximately 20 mil. Alternatively, the first polymer layer and the second polymer layer may have a thickness of between approximately 1 mil and approximately 40 mil. Alternatively, the first polymer layer and the second polymer layer may have a thickness of between approximately 0.01 mil and approximately 100 mil.

The first polymer layer and the second polymer layer may include materials such as polyethylene terephthalate (PET), biaxially oriented polyethylene terephthalate (BoPET), or polycyclohexylenedimethylene terephthalate (PCT). In some implementations, the graphene-containing electrothermal layer does not contain electrically conductive metal wires extending along the sheet except the lead wires proximate an edge of the sheet.

The heater control system may have a variable output having at least eight available output powers. Alternatively, the heater control system may have a variable output having two, three, four, five, six, seven, nine, ten, etc. output powers, or a sufficient number of output powers as to appear continuously variable within a range of output powers. The heater control system may include a wireless communication link to permit control of the seat heater by an application programming interface (API) operating on a mobile computing device. The mobile computing device may be a device such as a smartphone, a tablet, a laptop computer, or a dedicated seat heater control device. Alternatively, the heater control device may be integrated with the vehicle or may be controlled via a control device integrated with the vehicle.

The seat heater may include a first flexible sheet having the graphene-containing electrothermal layer and the first and second polymer layers, the first flexible sheet being disposed in a generally-horizontal portion of the seat and a second flexible sheet having the graphene-containing electrothermal layer and the first and second polymer layers, the second flexible sheet being disposed in a generally-vertical portion of the seat.

According to additional implementations of the invention, a method for manufacturing a seat heater for a vehicle includes steps of providing a first polymer layer, spreading a graphene-containing mixture on the first polymer layer to form an electrothermal layer on the first polymer layer, and placing a second polymer layer on the electrothermal layer to form a flexible sheet having the electrothermal layer sandwiched between the first and second polymer layers. The method also includes steps of cutting the flexible sheet to a shape adapted to provide heat to a desired area of a vehicle seat, affixing electrical leads to different areas of the electrothermal layer, and placing the flexible sheet under an outer covering of the desired area of the vehicle seat.

The flexible sheet may be shaped to conform to a shape of a portion of the vehicle seat. The graphene-containing electrothermal layer may have a thickness of approximately 0.01 mil. The first polymer layer and the second polymer layer may have a thickness of between approximately 5 mil and approximately 20 mil. Alternatively, the first polymer layer and the second polymer layer may have a thickness of between approximately 1 mil and approximately 40 mil. Alternatively, the first polymer layer and the second polymer layer may have a thickness of between approximately 0.01 mil and approximately 100 mil.

The first polymer layer and the second polymer layer may include materials such as PET, BoPET, or PCT. In some implementations, the graphene-containing electrothermal layer does not contain electrically conductive metal wires extending along the sheet except the lead wires proximate an edge of the sheet.

The flexible sheet may be affixed to the outer covering by a method such as gluing, bonding, or stitching. The method may further include operatively attaching the electrical leads to a heater control system. In some instances, the flexible sheet is cut into a first flexible sheet placed under a first desired area of the vehicle seat, and a second flexible sheet placed under a second desired area of the vehicle seat.

According to additional implementations, a seat heater for use in a vehicle seat includes a graphene-containing electrothermal layer, a first polymer layer contacting and extending along a first side of the graphene-containing electrothermal layer, and a second polymer layer contacting and extending along a second side of the graphene-containing electrothermal layer. The seat heater also includes lead wires connected between the graphene-containing electrothermal layer and a heater control system operatively connected to a power supply, the heater control system comprising a wireless communication link to permit control of the seat heater by an API operating on a mobile computing device. The graphene-containing electrothermal layer, the first polymer layer, and the second polymer layer form a flexible sheet that is disposed under a cover of a vehicle seat.

The flexible sheet may be shaped to conform to a shape of a portion of the vehicle seat. The graphene-containing electrothermal layer may have a thickness of approximately 0.01 mil. The first polymer layer and the second polymer layer may have a thickness of between approximately 5 mil and approximately 20 mil. Alternatively, the first polymer layer and the second polymer layer may have a thickness of between approximately 1 mil and approximately 40 mil. Alternatively, the first polymer layer and the second polymer layer may have a thickness of between approximately 0.01 mil and approximately 100 mil.

The first polymer layer and the second polymer layer may include materials such as PET, BoPET, or PCT. In some implementations, the graphene-containing electrothermal layer does not contain electrically conductive metal wires extending along the sheet except the lead wires proximate an edge of the sheet.

The heater control system may have a variable output having at least eight available output powers. Alternatively, the heater control system may have a variable output having two, three, four, five, six, seven, nine, ten, etc. output powers, or a sufficient number of output powers as to appear continuously variable within a range of output powers. The mobile computing device may be a device such as a smartphone, a tablet, a laptop computer, or a dedicated seat heater control device. Alternatively, the heater control device may be integrated with the vehicle or may be controlled via a control device integrated with the vehicle.

The seat heater may include a first flexible sheet having the graphene-containing electrothermal layer and the first and second polymer layers, the first flexible sheet being disposed in a generally-horizontal portion of the seat and a second flexible sheet having the graphene-containing electrothermal layer and the first and second polymer layers, the second flexible sheet being disposed in a generally-vertical portion of the seat.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows an illustrative vehicle seat in which a seat heater may be incorporated;

FIG. 2 shows an illustrative cross-sectional view of a portion of a flexible heating sheet in accordance with certain embodiments of the invention;

FIG. 3 shows an illustrative top view of a flexible heating sheet in accordance with certain embodiments of the invention; and

FIG. 4 shows an illustrative computing device that may be used in conjunction with embodiments of the invention.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the invention provide novel seat heaters, methods for manufacturing seat heaters, and methods for using seat heaters. According to an exemplary embodiment of the invention, a seat heater for use in a vehicle seat includes a graphene-containing electrothermal layer, a first polymer layer contacting and extending along a first side of the graphene-containing electrothermal layer, and a second polymer layer contacting and extending along a second side of the graphene-containing electrothermal layer. The seat heater also includes lead wires connected between the graphene-containing electrothermal layer and a heater control system operatively connected to a power supply. The graphene-containing electrothermal layer, the first polymer layer, and the second polymer layer form a flexible sheet that is disposed under a cover of a vehicle seat.

The flexible sheet may be shaped to conform to a shape of a portion of the vehicle seat. The graphene-containing electrothermal layer may have a thickness of approximately 0.01 mil. The first polymer layer and the second polymer layer may have a thickness of between approximately 5 mil and approximately 20 mil. Alternatively, the first polymer layer and the second polymer layer may have a thickness of between approximately 1 mil and approximately 40 mil. Alternatively, the first polymer layer and the second polymer layer may have a thickness of between approximately 0.01 mil and approximately 100 mil.

The first polymer layer and the second polymer layer may include materials such as polyethylene terephthalate (PET), biaxially oriented polyethylene terephthalate (BoPET), or polycyclohexylenedimethylene terephthalate (PCT). In some embodiments, the graphene-containing electrothermal layer does not contain electrically conductive metal wires extending along the sheet except the lead wires proximate an edge of the sheet.

The heater control system may have a variable output having at least eight available output powers. Alternatively, the heater control system may have a variable output having two, three, four, five, six, seven, nine, ten, etc. output powers, or a sufficient number of output powers as to appear continuously variable within a range of output powers. The heater control system may include a wireless communication link to permit control of the seat heater by an application programming interface (API) operating on a mobile computing device. The mobile computing device may be a device such as a smartphone, a tablet, a laptop computer, or a dedicated seat heater control device. Alternatively, the heater control device may be integrated with the vehicle or may be controlled via a control device integrated with the vehicle.

The seat heater may include a first flexible sheet having the graphene-containing electrothermal layer and the first and second polymer layers, the first flexible sheet being disposed in a generally-horizontal portion of the seat and a second flexible sheet having the graphene-containing electrothermal layer and the first and second polymer layers, the second flexible sheet being disposed in a generally-vertical portion of the seat.

According to additional embodiments of the invention, a method for manufacturing a seat heater for a vehicle includes steps of providing a first polymer layer, spreading a graphene-containing mixture on the first polymer layer to form an electrothermal layer on the first polymer layer, and placing a second polymer layer on the electrothermal layer to form a flexible sheet having the electrothermal layer sandwiched between the first and second polymer layers. The method also includes steps of cutting the flexible sheet to a shape adapted to provide heat to a desired area of a vehicle seat, affixing electrical leads to different areas of the electrothermal layer, and placing the flexible sheet under an outer covering of the desired area of the vehicle seat.

The flexible sheet may be shaped to conform to a shape of a portion of the vehicle seat. The graphene-containing electrothermal layer may have a thickness of approximately 0.01 mil. The first polymer layer and the second polymer layer may have a thickness of between approximately 5 mil and approximately 20 mil. Alternatively, the first polymer layer and the second polymer layer may have a thickness of between approximately 1 mil and approximately 40 mil. Alternatively, the first polymer layer and the second polymer layer may have a thickness of between approximately 0.01 mil and approximately 100 mil.

The first polymer layer and the second polymer layer may include materials such as PET, BoPET, or PCT. In some embodiments, the graphene-containing electrothermal layer does not contain electrically conductive metal wires extending along the sheet except the lead wires proximate an edge of the sheet.

The flexible sheet may be affixed to the outer covering by a method such as gluing, bonding, or stitching. The method may further include operatively attaching the electrical leads to a heater control system. In some instances, the flexible sheet is cut into a first flexible sheet placed under a first desired area of the vehicle seat, and a second flexible sheet placed under a second desired area of the vehicle seat.

According to additional embodiments, a seat heater for use in a vehicle seat includes a graphene-containing electrothermal layer, a first polymer layer contacting and extending along a first side of the graphene-containing electrothermal layer, and a second polymer layer contacting and extending along a second side of the graphene-containing electrothermal layer. The seat heater also includes lead wires connected between the graphene-containing electrothermal layer and a heater control system operatively connected to a power supply, the heater control system comprising a wireless communication link to permit control of the seat heater by an API operating on a mobile computing device. The graphene-containing electrothermal layer, the first polymer layer, and the second polymer layer form a flexible sheet that is disposed under a cover of a vehicle seat.

The flexible sheet may be shaped to conform to a shape of a portion of the vehicle seat. The graphene-containing electrothermal layer may have a thickness of approximately 0.01 mil. The first polymer layer and the second polymer layer may have a thickness of between approximately 5 mil and approximately 20 mil. Alternatively, the first polymer layer and the second polymer layer may have a thickness of between approximately 1 mil and approximately 40 mil. Alternatively, the first polymer layer and the second polymer layer may have a thickness of between approximately 0.01 mil and approximately 100 mil.

The first polymer layer and the second polymer layer may include materials such as PET, BoPET, or PCT. In some embodiments, the graphene-containing electrothermal layer does not contain electrically conductive metal wires extending along the sheet except the lead wires proximate an edge of the sheet.

The heater control system may have a variable output having at least eight available output powers. Alternatively, the heater control system may have a variable output having two, three, four, five, six, seven, nine, ten, etc. output powers, or a sufficient number of output powers as to appear continuously variable within a range of output powers. The mobile computing device may be a device such as a smartphone, a tablet, a laptop computer, or a dedicated seat heater control device. Alternatively, the heater control device may be integrated with the vehicle or may be controlled via a control device integrated with the vehicle.

The seat heater may include a first flexible sheet having the graphene-containing electrothermal layer and the first and second polymer layers, the first flexible sheet being disposed in a generally-horizontal portion of the seat and a second flexible sheet having the graphene-containing electrothermal layer and the first and second polymer layers, the second flexible sheet being disposed in a generally-vertical portion of the seat.

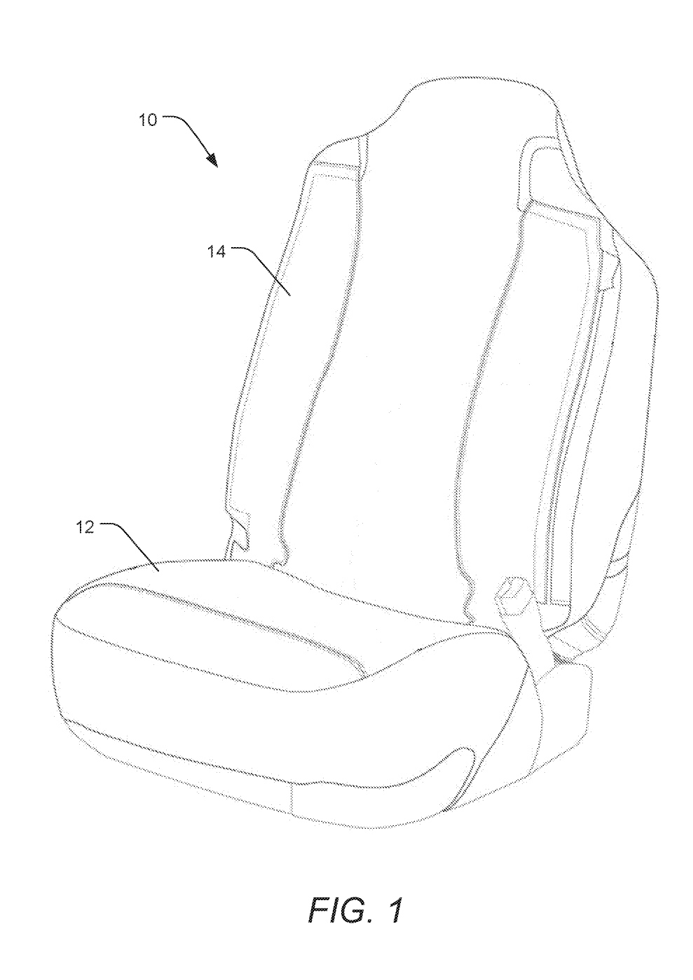

FIG. 1 shows an illustrative vehicle seat 10 that may incorporate a seat heater in accordance with embodiments of the invention. The seat 10 typically includes a seat portion 12 and a back portion 14. As is known in the art, the seat portion 12 may be viewed as being generally horizontal, although the seat portion 12 may be contoured and angled away from a strict horizontal orientation for comfort and convenience of the occupant. The seat 10 also includes a back portion 14, which may be viewed as being generally vertical, although the back portion 14 may also be contoured and angled away from a strict vertical orientation for comfort and convenience of the occupant. The exact position and angle of the seat portion 12 and the back portion 14 may be adjustable to maximize comfort and convenience for occupants of different body types, sizes, and weights.

As is known in the art, the seat 10 generally includes an underlying support structure (not shown in FIG. 1) that is typically formed of metal and provides sufficient support to support an occupant in typical use, as well as in the case of short-term large forces such as might be encountered in a vehicular collision. To improve comfort of the occupant, the underlying support structure is generally covered by layers of materials such as springs, foam, and an outer covering such as of cloth, leather, and/or vinyl or other synthetic material. The outer covering also serves to improve the appearance of the seat 10, and may include decorative features such as contrasting materials or colors, stitching, and the like.

Incorporating one or more seat heaters into the seat 10 may improve the comfort of the occupant, especially during cold periods of time, and especially before the engine of the vehicle has had sufficient time to warm up to a point where engine warmth may be used to warm the vehicle's occupants. In general, it is advantageous to provide seat heating at least on those portions of the seat 10 that are anticipated to be in contact with the occupant's body. Accordingly, embodiments of the invention embrace the provision of seat heating to at least an upper surface of the seat portion 12, and/or to at least a forward surface of the back portion 14. While traditional seat heaters only provided heating to limited portions of the upper surface of the seat portion 12 and/or to the forward surface of the back portion, in part to avoid issues of premature failure discussed in the background, embodiments of the invention permit heating to be delivered to as much of the upper surface of the seat portion 12 and/or to as much of the forward surface of the back portion 14 as may be desired.

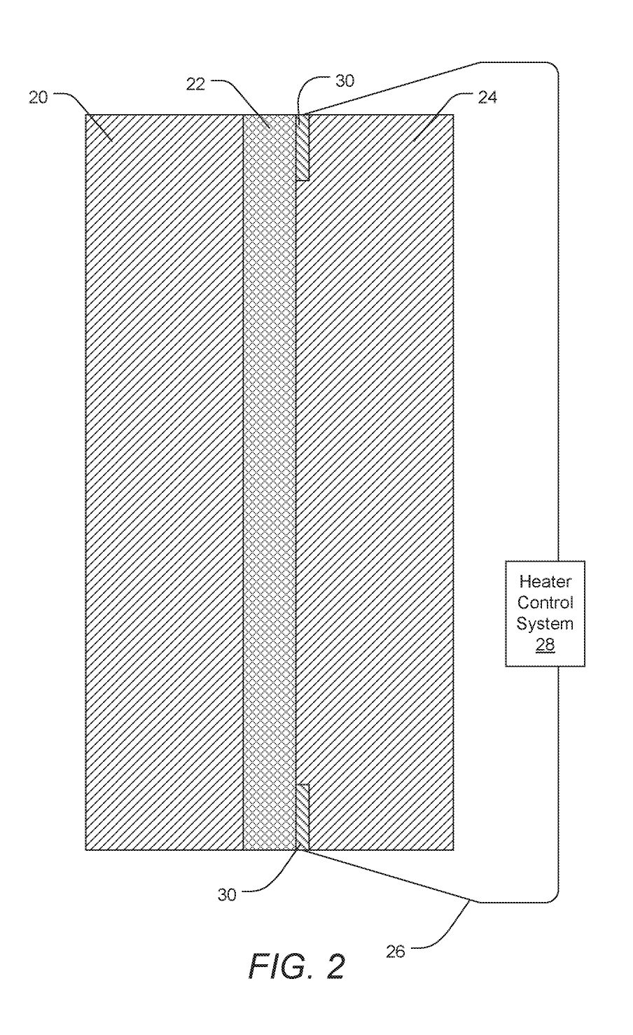

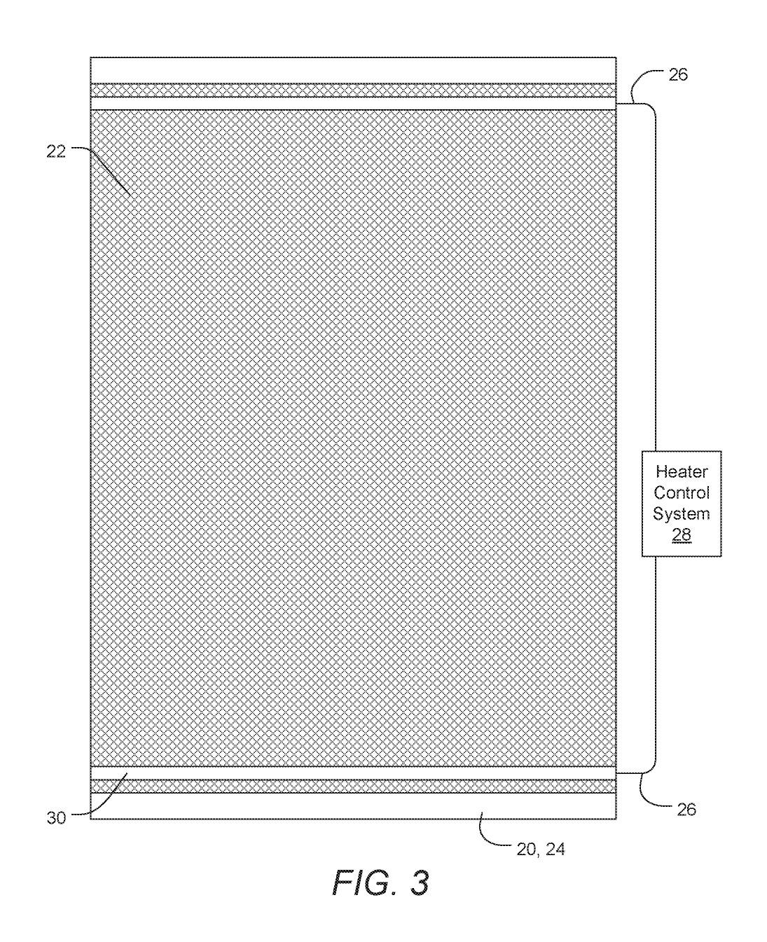

This may be achieved because of the flexible seat heater sheet structure illustrated in FIGS. 2 and 3. FIG. 2 illustrates a representative cross-sectional view (not shown to scale) of a portion of just one embodiment of a flexible seat heater sheet structure, and FIG. 3 shows a top view of one embodiment of a flexible seat heater sheet structure. The structure illustrated in FIG. 2 includes a first polymer layer 20, a graphene-containing electrothermal layer 22, and a second polymer layer 24. Each of these layers is generally flexible in nature, allowing the seat heater sheet structure to be conformed to any contours of the seat 10 in which the sheet structure is incorporated, and also for the sheet structure to deform and flex as the seat occupant enters the seat 10, exits the seat 10, and/or moves around within the seat 10.

While FIG. 2 illustrates the first polymer layer 20 and the second polymer layer 24 as being of equal thickness, the first polymer layer 20 and the second polymer layer 24 may be of different thicknesses. Each of the first polymer layer 20 and the second polymer layer 22 may be formed of or include a variety of polymer materials such as PET, BoPET, or PCT. The first polymer layer 20 and/or the second polymer layer 22 may have a thickness similar to the thickness of the electrothermal layer 22, or may have a thickness greater than the thickness of the electrothermal layer 22, up to any desired thickness maintaining desired strength and flexibility characteristics. The graphene-containing electrothermal layer 22 may be formed of the material known as Nanoxene, developed by Mr. Feng Liu of the University of Utah and now being marketed and/or further developed by Life-E, LLC of Sandy, Utah. This material is affordable, lightweight, and adaptable. It is made up of a proprietary advanced multicomponent nanocomposite material including graphene therein. Graphene is an advanced material that is versatile, strong, and an excellent conductor of heat and electricity.

One advantage of forming the electrothermal layer 22 of a graphene-containing material such as Nanoxene is that the heat output of the electrothermal layer 22 is readily tunable by varying the amount of energy supplied to the seat heater. Accordingly, a controller connected to the flexible sheet can be readily adapted to provide a variety of output levels, and the amount of heat generated can be tuned to a comfortable level without overheating the seat occupant. Additionally, because the entire electrothermal layer 22 is conductive, the flexible sheet is resistant to loss of functionality due to localized discontinuities within the electrothermal layer 22. If a localized discontinuity occurs, energy is simply conducted around the discontinuity, and the seat heater continues to function essentially as normal. The bulk conductivity of the Nanoxene material may be made several orders of magnitude higher than most conventional conducting films, with high conversion efficiency of electricity to heat.

Another advantage of the Nanoxene material's conductivity is that the material may be cut to fit or conform to any desired shape. By way of example, the flexible sheet having the electrothermal layer 22 may be cut to generally or closely match the shape of the upper surface of the seat portion 12 or to generally or closely match the shape of the front surface of the back portion 14, such that heat is distributed evenly to essentially the whole top surface of the seat portion 12 and/or to essentially the whole front surface of the back portion 14. After the flexible sheet is cut to size and shape, lead wires 26 may be operatively attached to the electrothermal layer 22 proximate opposing edges of the flexible sheet, and the lead wires 26 may be operatively attached to a heater control system 28 which provides controlled amounts of power to the flexible sheet. By way of example, the lead wires 26 may be attached to metal (e.g. copper) traces 30 disposed on and in contact with opposite edges of the electrothermal layer 22.

The heater control system 28 may provide any desired amount of flexibility in controlling the amount of heat output by the seat heater. By way of example, the heater control system 28 may be configured to have one, two, three, four, five, six, seven, eight, nine, ten, or more output levels, and may be configured to have a continuously variable output within its output range. The heater control system 28 may be operated or controlled using a wired or wireless connection to an in-vehicle control panel, or it may be operated via an API running on a mobile computing device.

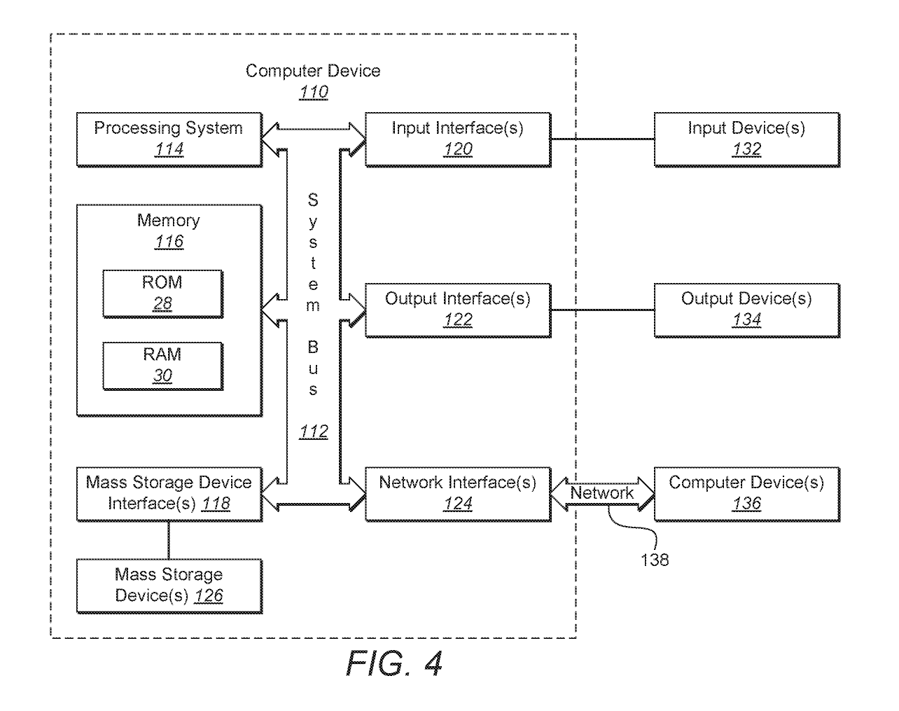

As embodiments of the invention may utilize an API operating on a mobile computing device, FIG. 4 and the corresponding discussion are intended to provide a general description of a suitable operating environment in which certain embodiments of the API may be implemented. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand alone electronic devices, and other such electronic environments.

Embodiments of the present invention embrace one or more computer-readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer-readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system. While embodiments of the invention embrace the use of all types of computer-readable media, certain embodiments as recited in the claims may be limited to the use of tangible, non-transitory computer-readable media, and the phrases “tangible computer-readable medium” and “non-transitory computer-readable medium” (or plural variations) used herein are intended to exclude transitory propagating signals per se.

With reference to FIG. 4, a representative system for implementing embodiments of the invention includes computer device 110, which may be a general-purpose or special-purpose computer or any of a variety of consumer electronic devices. For example, computer device 110 may be a notebook or laptop computer, a netbook, a personal digital assistant (“PDA”) or other hand-held device, a smart phone, a tablet computer, a processor-based consumer electronic device, a computer device integrated into another device or vehicle, or the like.

Computer device 110 includes system bus 112, which may be configured to connect various components thereof and enables data to be exchanged between two or more components. System bus 112 may include one of a variety of bus structures including a memory bus or memory controller, a peripheral bus, or a local bus that uses any of a variety of bus architectures. Typical components connected by system bus 112 include processing system 114 and memory 116. Other components may include one or more mass storage device interfaces 118, input interfaces 120, output interfaces 122, and/or network interfaces 124, each of which will be discussed below.

Processing system 114 includes one or more processors, such as a central processor and optionally one or more other processors designed to perform a particular function or task. It is typically processing system 114 that executes the instructions provided on computer-readable media, such as on memory 116, a magnetic hard disk, a removable magnetic disk, a magnetic cassette, an optical disk, or from a communication connection, which may also be viewed as a computer-readable medium.

Memory 116 includes one or more computer-readable media that may be configured to include or includes thereon data or instructions for manipulating data, and may be accessed by processing system 114 through system bus 112. Memory 116 may include, for example, ROM 128, used to permanently store information, and/or RAM 130, used to temporarily store information. ROM 128 may include a basic input/output system (“BIOS”) having one or more routines that are used to establish communication, such as during start-up of computer device 110. RAM 130 may include one or more program modules, such as one or more operating systems, application programs, and/or program data.

One or more mass storage device interfaces 118 may be used to connect one or more mass storage devices 126 to system bus 112. The mass storage devices 126 may be incorporated into or may be peripheral to computer device 110 and allow computer device 110 to retain large amounts of data. Optionally, one or more of the mass storage devices 126 may be removable from computer device 110. Examples of mass storage devices include hard disk drives, magnetic disk drives, solid state drives, tape drives and optical disk drives. A mass storage device 126 may read from and/or write to a magnetic hard disk, a removable magnetic disk, a magnetic cassette, an optical disk, or another computer-readable medium. Mass storage devices 126 and their corresponding computer-readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 120 may be employed to enable a user to enter data and/or instructions to computer device 110 through one or more corresponding input devices 132. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 120 that may be used to connect the input devices 132 to the system bus 112 include a serial port, a parallel port, a game port, a universal serial bus (“USB”), an integrated circuit, a firewire (IEEE 1394), or another interface. For example, in some embodiments input interface 120 includes an application specific integrated circuit (ASIC) that is designed for a particular application. In a further embodiment, the ASIC is embedded and connects existing circuit building blocks.

One or more output interfaces 122 may be employed to connect one or more corresponding output devices 134 to system bus 112. Examples of output devices include a monitor or display screen, a speaker, and the like. A particular output device 134 may be integrated with or peripheral to computer device 110. Examples of output interfaces include a video adapter, an audio adapter, a parallel port, and the like.

One or more network interfaces 124, which may be a wireless network interface, enable computer device 110 to exchange information with one or more other local or remote computer devices or heater controllers, illustrated as computer devices 136, via a connection such as network 138 (which may be a two-device wireless network) that may include hardwired and/or wireless links. The network interface 124 may be incorporated with or peripheral to computer device 110. In a networked system, accessible program modules or portions thereof may be stored in a remote memory storage device.

To construct the seat heater, the first polymer layer 20 may first be provided, and then Nanoxene material may be painted or spread on the first polymer layer so as to form the electrothermal layer 22. Then, the second polymer layer 24 may be disposed on the electrothermal layer 22, thereby creating a flexible sheet of sandwiched layers as illustrated in FIG. 2. The flexible sheet may be made of any desirable size, but will generally be at least slightly larger than the desired area to be heated. The flexible sheet may then be cut to size, and lead wires are attached to the properly sized sheet, with the lead wires making electrical contact with the electrothermal layer 22 on opposing sides of the sheet.

The properly sized flexible sheet is then disposed within the seat (e.g. under the outer cover of the seat portion 12 and/or the back portion 14), and may optionally be bonded, glued, stitched to, or otherwise attached to either the inside of the seat cover or to an underlying support layer (e.g. on top of an outermost foam layer) as the seat is assembled. The lead wires are operatively attached to the heater control system 28, and the seat heater can then be controlled by either physical controls within the vehicle or using the API as discussed above.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A seat heater for use in a vehicle seat comprising:
a graphene-containing electrothermal layer;
a first polymer layer contacting and extending along a first side of the graphene-containing electrothermal layer;
a second polymer layer contacting and extending along a second side of the graphene-containing electrothermal layer; and
lead wires connected between the graphene-containing electrothermal layer and a heater control system operatively connected to a power supply;
wherein the graphene-containing electrothermal layer, the first polymer layer, and the second polymer layer form a flexible sheet that is disposed under a cover of a vehicle seat.

2. The seat heater of claim 1, wherein the flexible sheet is shaped to conform to a shape of a portion of the vehicle seat.

3. The seat heater of claim 1, wherein the graphene-containing electrothermal layer has a thickness of approximately 0.01 mil.

4. The seat heater of claim 1, wherein the first polymer layer and the second polymer layer have a thickness of between approximately 5 mil and approximately 20 mil.

5. The seat heater of claim 1, wherein the first polymer layer and the second polymer layer comprise a material selected from the group consisting of:
polyethylene terephthalate (PET);
biaxially oriented polyethylene terephthalate (BoPET); and
polycyclohexylenedimethylene terephthalate (PCT).

6. The seat heater of claim 1, wherein the graphene-containing electrothermal layer does not contain electrically conductive metal wires extending along the sheet except the lead wires proximate an edge of the sheet.

7. The seat heater of claim 1, wherein the heater control system comprises a variable output having at least eight available output powers.

8. The seat heater of claim 1, wherein the heater control system comprises a wireless communication link to permit control of the seat heater by an application programming interface (API) operating on a mobile computing device.

9. The seat heater of claim 8, wherein the mobile computing device comprises a device selected from the group consisting of:
a smartphone;
a tablet;
a laptop computer; and
a dedicated seat heater control device.

10. The seat heater of claim 1, wherein the seat heater comprises:
a first flexible sheet having the graphene-containing electrothermal layer and the first and second polymer layers, the first flexible sheet being disposed in a generally-horizontal portion of the seat; and
a second flexible sheet having the graphene-containing electrothermal layer and the first and second polymer layers, the second flexible sheet being disposed in a generally-vertical portion of the seat.

11. A method for manufacturing a seat heater for a vehicle, the method comprising:
providing a first polymer layer;
spreading a graphene-containing mixture on the first polymer layer to form an electrothermal layer on the first polymer layer;
placing a second polymer layer on the electrothermal layer to form a flexible sheet having the electrothermal layer sandwiched between the first and second polymer layers;
cutting the flexible sheet to a shape adapted to provide heat to a desired area of a vehicle seat;
affixing electrical leads to different areas of the electrothermal layer; and
placing the flexible sheet under an outer covering of the desired area of the vehicle seat.

12. The method as recited in claim 11, wherein the electrothermal layer has a thickness of approximately 0.01 mil.

13. The method as recited in claim 11, wherein the first polymer layer and the second polymer layer comprise a material selected from the group consisting of:
polyethylene terephthalate (PET);
biaxially oriented polyethylene terephthalate (BoPET); and
polycyclohexylenedimethylene terephthalate (PCT).

14. The method as recited in claim 11, wherein the flexible sheet is affixed to the outer covering by a method selected from the group consisting of:
gluing;
bonding; and
stitching.

15. The method as recited in claim 11, further comprising operatively attaching the electrical leads to a heater control system.

16. The method as recited in claim 11, wherein the flexible sheet is cut into a first flexible sheet placed under a first desired area of the vehicle seat, and a second flexible sheet placed under a second desired area of the vehicle seat.

17. A seat heater for use in a vehicle seat comprising:
a graphene-containing electrothermal layer;
a first polymer layer contacting and extending along a first side of the graphene-containing electrothermal layer;
a second polymer layer contacting and extending along a second side of the graphene-containing electrothermal layer; and
lead wires connected between the graphene-containing electrothermal layer and a heater control system operatively connected to a power supply, the heater control system comprising a wireless communication link to permit control of the seat heater by an application programming interface (API) operating on a mobile computing device;
wherein the graphene-containing electrothermal layer, the first polymer layer, and the second polymer layer form a flexible sheet that is disposed under a cover of a vehicle seat.

18. The seat heater of claim 17, wherein the graphene-containing electrothermal layer has a thickness of approximately 0.01 mil.

19. The seat heater of claim 17, wherein the mobile computing device comprises a device selected from the group consisting of:
a smartphone;
a tablet;
a laptop computer; and
a dedicated seat heater control device.

20. The seat heater of claim 17, wherein the first polymer layer and the second polymer layer comprise a material selected from the group consisting of:
polyethylene terephthalate (PET);
biaxially oriented polyethylene terephthalate (BoPET); and
polycyclohexylenedimethylene terephthalate (PCT).
